(19) United States
(12) Patent Application Publication
(10) Pub. No.: US 2008/0136728 A1
(43) Pub. Date: Jun. 12, 2008

(54) Impedance matching method, a method for manufacturing signal processing circuits and a signal processing circuit and a radio apparatus using the same

(76) Inventor: Seiichi Banba, Ohgaki-shi (JP)

Correspondence Address: MCDERMOTT WILL & EMERY LLP, 600 13TH STREET, N.W., WASHINGTON, DC, 20005-3096, US

(21) Appl. No.: 11/896,290

(22) Filed: Aug. 30, 2007

(30) Foreign Application Priority Data
Aug. 30, 2006 (JP) 2006-233569
Jul. 2, 2007 (JP) 2007-174213

(51) Int. Cl. H01Q 1/50; H01Q 17/00

(52) U.S. Cl. 343/861; 29/601

(57) ABSTRACT

An embodiment of the present invention relates to impedance matching applied to a radio apparatus having an antenna. The antenna transmits and receives a signal of a predetermined frequency band. A high-frequency signal processing unit performs a signal processing on the signal transmitted from and received by the antenna. The signal path connects the antenna with the high-frequency processing unit. The signal path is structured in a manner such that, at one point between the antenna and the high-frequency signal processing unit, the signal path is branched out to a plurality of branched line paths that each include at least an inductance component and a capacitance component and, at another point between them, the respective branched-out branched line paths are gathered. By adjusting the number of a plurality of branched line paths, the impedance is matched in the predetermined frequency band.

### CROSS-REFERENCE TO RELATED APPLICATIONS

This application is based upon and claims the benefit of priority from both the prior Japanese Patent Applications No. 2006-233569, filed on Aug. 30, 2006 and No. 2007-174213, filed on Jul. 2, 2007, the entire contents of which are incorporated herein by references.

### BACKGROUND OF THE INVENTION

1. Field of the Invention

The present invention relates to an analog circuit technology and, more particularly, to an impedance matching method for matching impedances in a high-frequency analog circuit, a method for manufacturing signal processing circuits, and a signal processing circuit and a radio apparatus using the impedance matching method.

2. Description of the Related Art

In recent years, various high-speed data communication schemes represented by UWB (Ultra Wide Band) have been proposed to achieve a higher data transmission rate in data communications. In the high-speed data communications, various circuits mounted on communication equipment must meet the broadband capability standards. The broadband capability means that a frequency band in use is distributed in a wide spectrum. This entails many difficulties as compared with narrow-band processing.

For example, a wide-band impedance matching must be achieved when an LNA (Low Noise Amplifier) is used in UWB. This impedance matching depends on the impedance across a signal line provided from the LNA to an antenna. In general, the signal lines are packaged within an IC (Integrated Circuit) and there are provided a plurality of lead pins, bonding wires and the like. Accordingly, the IC needs to be designed in consideration of impedances attributable to these signal lines. In a conventional practice, the impedance matching is achieved by adjusting the impedance value of the IC, particularly, the bonding wires contained in the signal lines.

In general, the bonding wires and the like contained in the signal lines are known to have parasitic components where the characteristic thereof varies largely depending on the frequency. Here, when the frequency band in use is a wide band, the parasitic components in the bonding wires and the like vary largely depending on the frequency. Thus a problem arises where a matching state of the impedance is not stabilized.

### SUMMARY OF THE INVENTION

The present invention has been made in view of the foregoing circumstances, and a general purpose thereof is to provide an impedance matching method that realizes a stabilized impedance matching, a method for manufacturing signal processing circuits, and a signal processing circuit and a radio apparatus using said impedance matching method.

In order to resolve the above-described problems, a signal processing circuit according to one embodiment of the present invention comprises: an antenna which transmits and receives a signal of a predetermined frequency band; a high-frequency signal processing unit which performs a signal processing on the signal transmitted from and received by the antenna; and a signal path which connects the antenna with the high-frequency processing unit. The signal path is structured in a manner such that, at one point between the antenna and the high-frequency signal processing unit, the signal path is branched out to a plurality of branch (branched) line paths that each include at least an inductance component and a capacitance component and, at another point therebetween, the respective branched-out branched line paths are combined together; and the number of the plurality of branched line paths is adjusted in a manner such that an impedance across the signal path leading from the high-frequency signal processing unit to the antenna is matched with an impedance of the high-frequency signal processing unit in the frequency band.

It is to be noted that any arbitrary combination of the aforementioned constituting elements, and the implementation of the present invention in the form of a manufacturing method, a method, an apparatus and so forth may also be effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a diagram showing an exemplary structure of a radio apparatus according to an embodiment of the present invention;

FIG. 2 is a diagram showing an exemplary structure of a high-frequency signal processing unit and a signal path shown in FIG. 1;

FIG. 3 is a diagram schematically showing an exemplary structure of a first equivalent circuit of branched line paths shown in FIG. 2;

FIG. 4 is a diagram schematically showing an exemplary structure of a second equivalent circuit of a high-frequency signal processing unit shown in FIG. 2;

FIG. 5 is a graph showing an example of a first frequency characteristic in a radio apparatus shown FIG. 1;

FIG. 6 is a graph showing an example of a second frequency characteristic in a radio apparatus shown in FIG. 1;

FIG. 7 is a flowchart to perform impedance matching in a radio apparatus shown in FIG. 1; and

FIGS. 8A to 8D illustrate exemplary structures of modifications to an embodiment of the present invention.

### DETAILED DESCRIPTION OF THE INVENTION

The invention will now be described by reference to the preferred embodiments. This does not intend to limit the scope of the present invention, but to exemplify the invention.

An outline of the present invention will be given before a detail description of embodiments. A radio apparatus according to an embodiment of the present invention has characteristics where a satisfactory impedance matching state is stably maintained in a desired frequency band. The radio apparatus according to the present embodiment is suitable for wide-band communications such as UWB.

In general, a radio apparatus compatible with UWB is provided with a microwave-band low-noise amplifier. In the microwave-band low-noise amplifier, it is desired to achieve an excellent gain, noise factor, input matching and the like. However, desired characteristics cannot be obtained unless assembly-related parasitic components such as lead pins and boding wires connected to the microwave-band low-noise amplifier are taken into consideration in a design phase.

At the same time, the input matching needs to be met, over an ultra-wideband, to design a low noise amplifier assuming a communication scheme that uses an ultra-wideband like UWB. For this purpose, an amplifier with LC ladder matching network or distributed amplifier is used as a circuit component. In such a circuit configuration, a design needs to be made so that a resistance value is stabilized at, for example, 50 Ohms in order that the impedance in a path leading from an amplifier to an antenna does not vary depending on the frequency. However, it is difficult to achieve a design where an assembly-related reactance component is taken into account.

In view of the above-described circumstances, the present embodiment achieves an excellent operation of the amplifier over a wideband even in a practical assembly mode. More specifically, the frequency dependency of impedance at an antenna side, where the amplifier is located at a base point here, is reduced and a design is made so that the impedance stays almost fixed. Though the detail will be discussed later, a radio frequency (RF) signal path (hereinafter referred to as “signal path”) is provided in plurality or a capacitor for use in adjustment is added in an electrode pad. This reduces an imaginary component of impedance smaller, so that the frequency dependency of impedance can be reduced. Accordingly, the impedance across a band in use does not vary so much and can be almost stabilized at a fixed level. Further, the impedance is turned into a pure resistance component, so that the impedance matching with the amplifier can be easily realized. For convenience of explanation, a description is given hereunder of the impedance matching about a receiving system, and the description on a transmitting system is omitted.

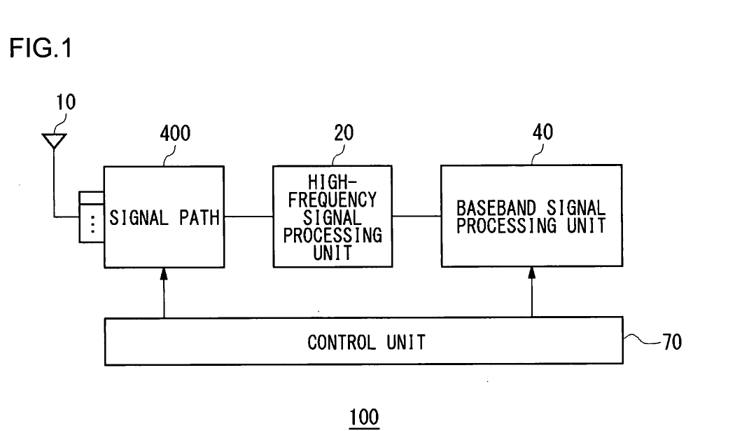

FIG. 1 is a diagram showing an exemplary structure of a radio apparatus 100 according to an embodiment of the present invention. The radio apparatus 100 includes an antenna 10, a signal path 400, a high-frequency signal processing unit 20, a baseband signal processing unit 40 and a control unit 70. The antenna 10 receives signals transmitted from a radio apparatus of a communicating party (not shown). The signal path 400 conveys the signals from the antenna 10, to the high-frequency signal processing unit 20. The high-frequency signal processing unit 20 performs a predetermined high-frequency signal processing on the signals from the signal path 400. The baseband signal processing unit 40 performs demodulation processing and the like on the signals which have been processed by the high-frequency signal processing 20. The control unit 70 controls operations of the high-frequency signal processing unit 20 and the baseband signal processing unit 40, respectively.

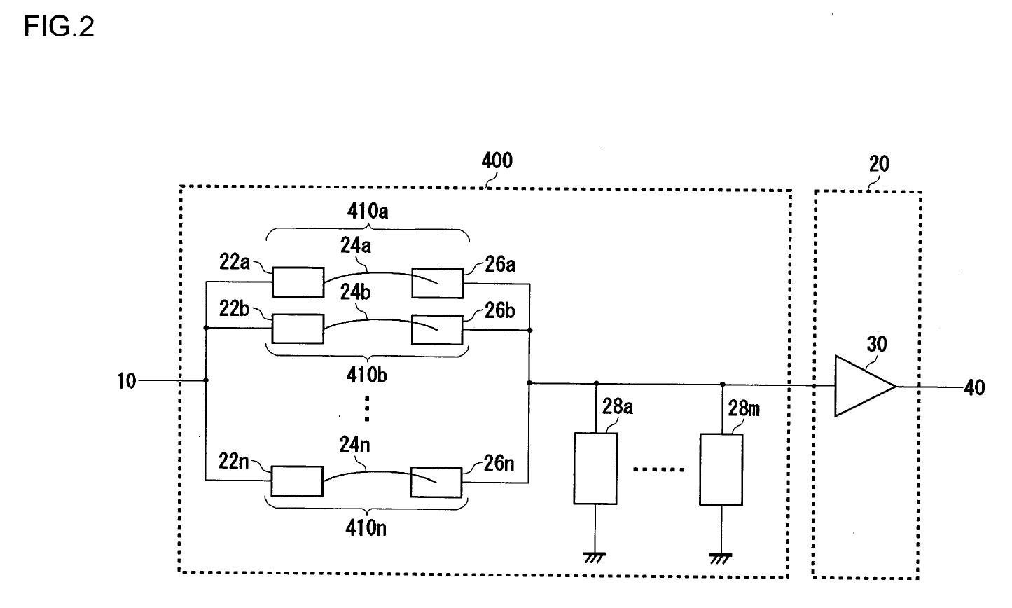

FIG. 2 is a diagram showing an exemplary structure of the high-frequency signal processing unit 20 and the signal path 400 shown in FIG. 1. The signal path 400 and the high-frequency signal processing unit 20 are provided between the antenna 10 and the baseband signal processing unit 40, and may come in an RFIC (Radio Frequency Integrated Circuit) where a plurality of analog elements are packaged therein. In the present embodiment, the high-frequency signal processing 20 includes an amplifier circuit 30. Though the amplifier circuit 30 only is shown in FIG. 2, other circuit components may be included. The signal path 400 includes a first capacitive unit 28a to an m-th capacitive unit 28m, which are represented by “capacitive unit 28”. The number of the capacitive units 28 is m. The signal path 400 includes a first branched line path 410a to an nth branched line path 410n, which are represented by “branched line path 410”. As shown in FIG. 2, the signal path 400 is structured in a manner such that at one point between the antenna 10 and the high-frequency signal processing unit 20 the signal path 400 is branched out to a plurality of branched line paths 410 that each include at least an inductance component and a capacitance component and at another point therebetween the respective branched-out branched line paths 410 are converged or gathered.

The branched line paths 410 include a first lead pin 22a to an nth lead pin 22n, respectively, which are represented by “lead pin 22”, a first bonding wire 24a to an nth bonding wire 24n, respectively, which are represented by “bonding wire 24”, and a first electrode pad 26a to an nth electrode pad 26n, respectively, which are represented by “electrode pad 26”. The number of lead pins 22, the number of bonding wires 24 and the number of electrode pads 26 are each n. For convenience of explanation, other structures concerning the high-frequency processing, such as an oscillator and a filter, are omitted in FIG. 2.

As shown in FIG. 2, the antenna 10 is connected to the high-frequency signal processing unit 20 by way of the signal path 400. The number of branched line paths 410 is adjusted according to the frequency band that a signal to be processed has. The detail will be discussed later. The capacitive unit 28 may be provided for the purpose of preventing electrostatic breakdown in the high-frequency signal processing unit 20. The number of capacitive units 28 may be adjusted according to the frequency band that a signal to be processed has. The amplifier circuit 30 included in the high-frequency signal processing unit 20 amplifies the amplitude of a signal received via the signal path 400 and conveys the amplified amplitude thereof to the baseband signal processing unit 40.

In general, the impedance at an antenna side, where the amplifier within a chip is located at a base point here, is not constant over frequency and is heavily dependent on the frequency due to the parasitic components such as the bonding wires and lead pins in the signal path 400. In the light of this, a circuit suitable for a wide band matching is provided by minimizing the effect of the parasitic components caused when a plurality of lead pins, bonding wires, pad electrodes and the like are combined.

The impedance matching in the radio apparatus 100 according to the present embodiment is carried out by the following procedure.

(1) Obtain an equivalent circuit and derive an equation for deriving the impedance of the entire circuit.

(2) Derive a coefficient of the equivalent circuit and substitute the thus derived coefficient into the equation derived in (1).

(3) Set a frequency characteristic in the equation obtained in (2) as an object function, and optimize the number n of signal paths 400 and the number m of capacitive units 28.

(4) The number n of signal paths 400 and the number m of capacitive units 28 obtained in (3) are substituted into the equation obtained in (2) so as to obtain the impedance across a path leading from the amplifier circuit 30 to the antenna 10. Further, the impedance of the amplifier circuit 30 is set to the impedance value obtained above.

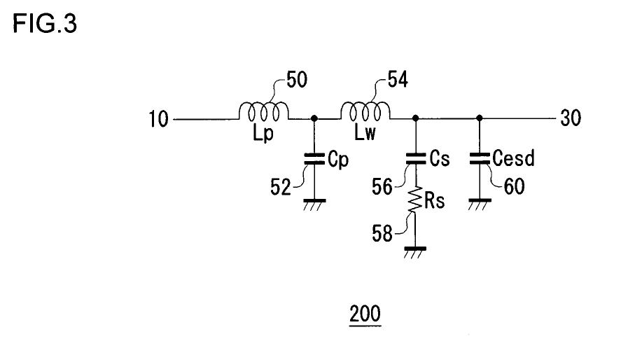

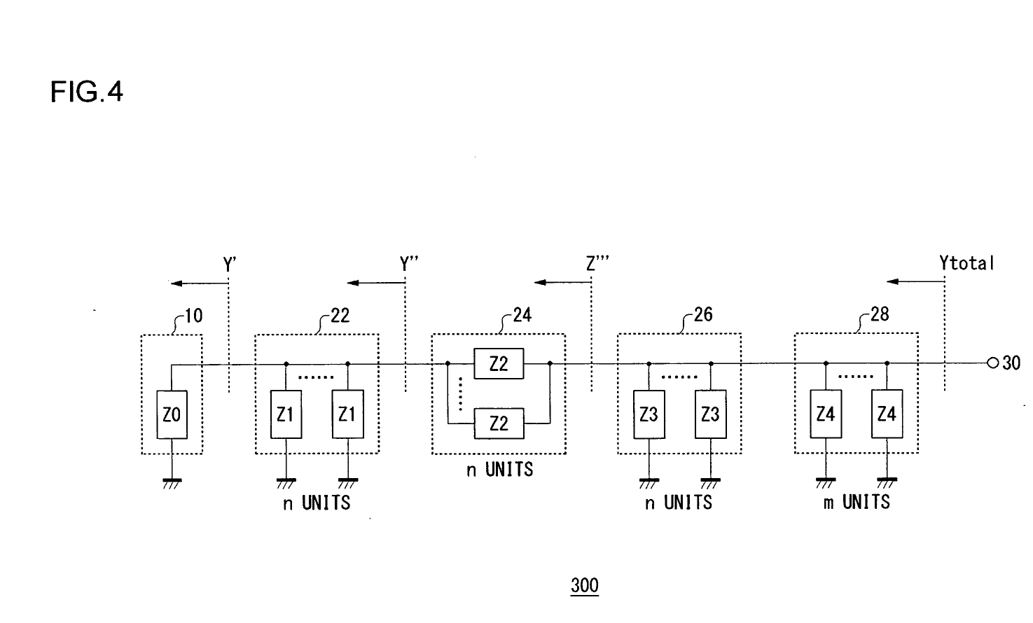

To clarify the description of the equivalent circuit shown in FIG. 2 with reference to FIG. 4 described later, shown here is an equivalent circuit, to be compared, in terms of the elements thereof in a case when the high-frequency signal processing unit 20 is configured in a simplified manner, that is, a case when there is a single branched line path 410. FIG. 3 is a diagram schematically showing an exemplary structure of a first equivalent circuit 200 of the branched line path 410 shown in FIG. 2. The first equivalent circuit 200 includes a first inductor 50, a first capacitor 52, a second inductor 54, a second capacitor 56, a first resistor 58, and a third capacitor 60.

The first inductor 50 and the first capacitor 52 correspond to the equivalent circuit of the lead pin 22 shown in FIG. 2. The second inductor 54 corresponds to the equivalent circuit of the bonding wire 24 shown in FIG. 2. The second capacitor 56 and the first resistor 58 correspond to the equivalent circuit of the electrode pad 26 shown in FIG. 2. The third capacitor 60 corresponds to the equivalent circuit of the capacitive unit 28. Note that each equivalent circuit is obtained from an equivalent circuit analysis and the like by an electromagnetic field simulation or sample measurement. Here, the first inductor 50 has a parasitic inductance denoted by Lp.

The first capacitor 52 has a parasitic capacitance denoted by Cp. The second inductor 54 has a parasitic inductance denoted by Lw. The second capacitor 56 has a parasitic capacitance denoted by Cs. The first resistor 58 has a resistance value denoted by Rs. The third capacitor 60 has a parasitic capacitance denoted by Cesd.

As shown in FIG. 3, the lead pin 22 has the inductance Lp and the capacitance Cp as parasitic components. Specific values of Lp and Cp can be calculated from an analysis, by an electromagnetic simulator or the like, together with their forms or the like. Since the frequency band of signals to be processed in the present embodiment is a microwave band, the length of the lead pin 22 used here is short and therefore the value of Lp is small. The main parasitic component of the bonding wire 24 is the inductance Lw. Similarly to Lp and the like, this Lw can also be calculated from its form. Note that the value of Lw may be calculated by use of an approximation formula.

Shown next is an equivalent circuit where there are a plurality of branched line paths 410 leading from the antenna 10 to the high-frequency signal processing unit 20 as shown FIG. 2. FIG. 4 is a diagram schematically showing an exemplary structure of a second equivalent circuit 300 of the high-frequency signal processing unit 20 shown in FIG. 2. The second equivalent circuit 300 is an equivalent circuit where there are provided a plurality of signal paths 400 and a plurality of capacitive units 28 shown in FIG. 2. In the second equivalent circuit 300, the respective parasitic inductances or parasitic capacitances are denoted by Z's.

As shown by dotted lines in FIG. 4, Z0 indicates the impedance of the antenna of FIG. 2. Z1 indicates the impedance of the lead pin 22. Z2 indicates the impedance of the bonding wire 24 of FIG. 2. Z3 indicates the impedance of the electrode pad 26 of FIG. 2. Z4 indicates the impedance of the capacitive unit 28 of FIG. 2. As described above, the value of the inductance Lp is relatively small. Thus, for simplicity, Lp is ignored here. In FIG. 4, Y′, Y″, Z′″, Ytotal are the admittance or impedance of circuits located to the left of a reference position indicated therein.

Here, if a reference impedance of the antenna 10 is denoted by R, the parasitic capacitance of the lead pin 22 by Cp, the parasitic inductance of the bonding wire 24 by Lw, the parasitic components of the electrode pad 26 by Cs and Rs, respectively, and the parasitic capacitance of the capacitive unit 29 by Cesd, then Y0 to Y4 or Z0 to Z4 are expressed by the following equations. Y0 to Y4 indicate the admittances of Z0 to Z4, respectively.

$$\begin{matrix}{Z}_{0} = \frac{1}{{Y}_{0}} = R & Equation ( 1 ) \\ {Z}_{1} = \frac{1}{{Y}_{1}} = - j \frac{1}{ω {C}_{p}} & Equation ( 2 ) \\ {Z}_{2} = \frac{1}{{Y}_{2}} = j ω {L}_{W} & Equation ( 3 ) \\ {Z}_{3} = \frac{1}{{Y}_{3}} = {R}_{S} - j \frac{1}{ω {C}_{S}} & Equation ( 4 ) \\ {Z}_{4} = \frac{1}{{Y}_{4}} = - j \frac{1}{ω {C}_{esd}} & Equation ( 5 )\end{matrix}$$

Based on the second equivalent circuit 300 shown in FIG. 4, Y′, Y″, Z′″ Y′″) and Ytotal are expressed as follows.

$$\begin{matrix}{Y}^{′} = \frac{1}{{Z}^{′}} = {Y}_{0} = \frac{1}{{Z}_{0}} & Equation ( 6 ) \\ {Y}^{′′} = \frac{1}{{Z}^{′′}} = {Y}_{0} + n \cdot {Y}_{1} = \frac{1}{{Z}_{0}} + \frac{n}{{Z}_{1}} & Equation ( 7 ) \\ {Z}^{′′′} = \frac{1}{{Y}^{′′′}} = \frac{1}{{Y}^{′′}} + \frac{{Z}_{2}}{n} & Equation ( 8 ) \\ {Y}^{′′′} \frac{{Z}_{1} + n \cdot {Z}_{0}}{{Z}_{0} {Z}_{1} + \frac{{Z}_{1} {Z}_{2}}{n} + {Z}_{0} {Z}_{2}} & Equation ( 9 ) \\ {Y}_{total} = {Y}^{′′′} + n \cdot {Y}_{3} + m \cdot {Y}_{4} = \frac{{Z}_{1} + n \cdot {Z}_{0}}{{Z}_{0} {Z}_{1} + \frac{{Z}_{1} {Z}_{2}}{n} + {Z}_{0} {Z}_{2}} + \frac{n}{{Z}_{3}} + \frac{m}{{Z}_{4}} & Equation ( 10 )\end{matrix}$$

Now, substituting Equations (1) to (5) into Equation (10) derives the admittance Ytotal or the impedance Ztotal at an antenna 10 side where the high-frequency signal processing unit 20 is located at a base point here, as a function of frequency (ω=2πf), as follows.

$$\begin{matrix}{Y}_{total} = Re ( {Y}_{total} ) + j \cdot Im ( {Y}_{total} ) & Equation ( 11 ) \\ {Z}_{total} = \frac{Re ( {Y}_{total} ) - j \cdot Im ( {Y}_{total} )}{{[ Re ( {Y}_{total} ) ]}^{2} + {[ Im ( {Y}_{total} ) ]}^{2}} & Equation ( 12 ) \\ Re ( {Y}_{total} ) = \frac{R}{{( ω {L}_{W} R \cdot \frac{1}{n} )}^{2} + {( {ω}^{2} {L}_{W} {C}_{P} - 1 )}^{2}} + n \cdot \frac{{ω}^{2} {C}_{S}^{2} {R}_{S}}{{( ω {R}_{S} {C}_{S} )}^{2} + 1} & Equation ( 13 ) \\ Im ( {Y}_{total} ) = \frac{- {ω}^{2} {R}^{2} {L}_{W} \cdot \frac{1}{n} - n ω {C}_{P} ( {ω}^{2} {L}_{W} {C}_{P} - 1 )}{{( ω {L}_{W} R \cdot \frac{1}{n} )}^{2} + {( {ω}^{2} {L}_{W} {C}_{P} - 1 )}^{2}} + n \cdot \frac{ω {C}_{S}}{{( ω {R}_{S} {C}_{S} )}^{2} + 1} + m ω {C}_{esd} & Equation ( 14 )\end{matrix}$$

Here, coefficients n and m are adjusted so that Im(Ytotal) of Equation (14) in a desired frequency band becomes 0 and a derivative value of Re(Ytotal) of Equation (13) in a desired frequency band becomes 0. Since Im(Ytotal) is 0, the admittance Ytotal can be turned into a pure conductance. As a result thereof, the impedance matching can be achieved by merely setting the parasitic components of the amplifier circuit 30 to the resistance components. Also, since the derivative value of Re(Ytotal) is 0, the frequency dependency of the admittance Ytotal can be eliminated. That is, even if the frequency changes, the admittance Ytotal does not vary but stays fixed.

### If a frequency satisfying such characteristics exists over a wide band, the radio apparatus 100 can obtain a wide-band matching characteristic.

Next, equivalent circuit constants are obtained. A description is now given using a specific example. The lead pin 22 as shown in FIG. 2 can be expressed by the inductance Lp and the capacitance Cp with respect to the ground and can be directly calculated from the forms thereof by an analysis using an electromagnetic field simulator. The main parasitic component of the bonding wire 24 is the inductance Lw. Although this Lw can also be calculated from its form by use of the electromagnetic field simulator, the inductance value may be calculated by use of an approximation formula. Such equivalence circuit constants are as follows.

The inductance (Lp) of the lead pin 22=0.2 nH Equation (15)

The capacitance (Cp) of the lead pin 22 with respect to the ground=0.13 pF Equation (16)

The inductance (Lw) of the bonding wire 24=2.0 nH Equation (17)

A parasitic component is present in the electrode pad 26 formed on a Si semiconductor substrate where a substrate capacitance Cs and a substrate resistance Rs connected in series are inserted between the electrode pad 26 and a ground potential. And this parasitic component can be measured and extracted by S-parameter evaluation. Note that the areas of a plurality of electrode pads 26 are each identical to one another in the present embodiment.

The substrate capacitance (Cs) of the electrode pad 26=0.18 pF Equation (18)

The substrate resistance (Rs) of the electrode pad 26=550Ω Equation (19)

The capacitive unit 28 functions as an electrostatic breakdown protection circuit (hereinafter referred to as ESD (Electric Static Discharge) also) in the high-frequency signal processing unit 20. The ESD is loaded into the electrode pad 26 through a diode connection of a diode or an FET (Field Effect Transistor). In an example described later, the connection of a diode of FET is used. Also, the capacitance Cesd with respect to the ground is given as an equivalent circuit of ESD. If the ESD is not loaded, it can be substituted by the equal capacitance.

The capacitance (Cesd) of unit ESD with respect to the ground=0.05 pF Equation (20)

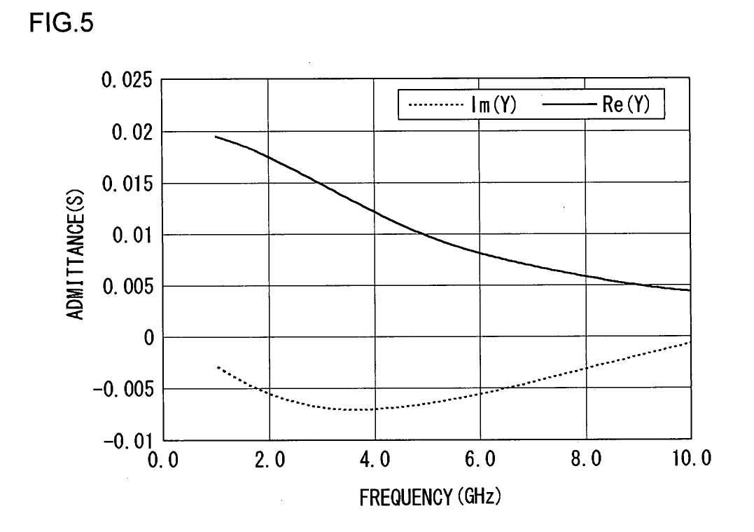

Here, frequency characteristics are shown where the parasitic components and the equivalent circuit constants given by Equations (15) to (20) are substituted into Equations (13) and (14). FIG. 5 is a graph showing an example of a first frequency characteristic in the radio apparatus 100 shown FIG. 1. The horizontal axis indicates the frequency and the vertical axis the admittance Ytotal. In this first frequency characteristic, the real component of admittance Ytotal is indicated by the solid line whereas the imaginary component thereof is indicated by the dotted line. It is assumed here that n=1 and m=2.

As shown in FIG. 5, the real component of the admittance Ytotal lies approximately within the range of +0.004 to +0.02. The imaginary component thereof lies approximately within the range of −0.007 to −0.001. Assume herein that the frequency used in the radio apparatus 100 as shown in FIG. 1 lies between 3 and 5 GHz. Then the imaginary component of the admittance Ytotal will fall approximately within the range of almost fixed values between +0.01 and +0.015. Also, the imaginary component will have a value close to 0 in a range of −0.007 and −0.001.

As described above, the frequency dependency of impedance across the path leading from the high-frequency signal processing unit 20 to the antenna 10 can be nearly eliminated by simply providing the radio apparatus 100 with one branched line path 410 and two capacitive units 28. Also, the impedance matching proves to be achieved by adjusting the impedance of the high-frequency signal processing unit 20 in such a manner as to lie within the range of +0.01 to +0.015. Also, since the stability of the impedance across the path leading from the high-frequency signal processing unit 20 to the antenna 10 is robust against the variation in frequency, the impedance matching state is stabilized.

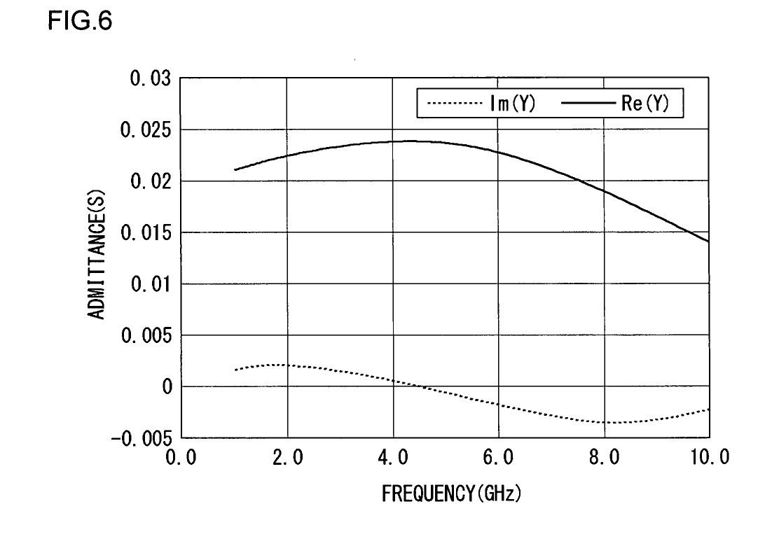

Another example is now described. FIG. 6 is a graph showing an example of a second frequency characteristic in the radio apparatus 100 shown in FIG. 1. Similar to FIG. 5, the real component of admittance Ytotal is indicated by the solid line whereas the imaginary component thereof is indicated by the dotted line. It is assumed here that n=2 and m=4.

As shown in FIG. 6, the real component of the admittance Ytotal lies approximately within the range of +0.014 to +0.024. The imaginary component thereof lies approximately within the range of −0.004 to +0.002. Assume herein that the frequency used in the radio apparatus 100 as shown in FIG. 1 lies between 3 and 5 GHz. Then the real component of the admittance Ytotal will fall approximately within the range of almost fixed values between +0.023 and +0.024 and the imaginary component thereof will have a value close to 0 in a range of −0.001 and +0.001.

As described above, the frequency dependency of impedance across the path leading from the high-frequency signal processing unit 20 to the antenna 10 can be further eliminated by simply providing the radio apparatus 100 with two branched line paths 410 and four capacitive units 28. Also, the impedance matching proves to be achieved by adjusting the impedance of the high-frequency signal processing unit 20 in such a manner as to lie within the range of +0.023 to +0.024. In this case, the impedance of the high-frequency signal processing unit 20 can be expressed by a resistance component alone, so that adjustment can be made easily. Also, since the stability of the impedance across the path leading from the high-frequency signal processing unit 20 to the antenna 10 is robust against the variation in frequency, the impedance matching state is further stabilized. As compared with the example shown in FIG. 5, the imaginary component in the example shown in FIG. 6 is closer to 0 and the range of the real component in a desired frequency band becomes nearly fixed, so that the condition with n=2 and m=4 in FIG. 6 is an optimum condition as compared with the example shown in FIG. 5.

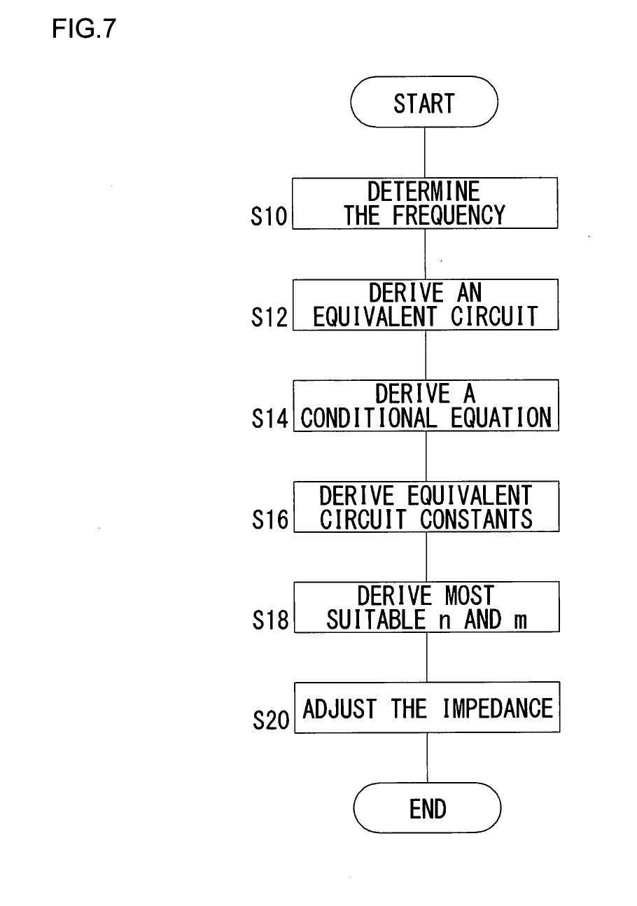

FIG. 7 is a flowchart to perform impedance matching in a radio apparatus 100 shown in FIG. 1. First, the frequency band to be used in the radio apparatus 100 is determined (S10). Then an equivalent circuit is derived as shown in FIG. 4 (S12). Conditional equations expressed in a function of frequency as in Equations (13) and (14) are derived based on the derived equivalent circuit (S14). Further, equivalent circuit constants as indicated by Equations (16) to (20) are derived (S16) and substituted into the conditional equations derived in S14. Then the optimum number m of branched line paths 410 and the optimum number n of capacitive units 28 are derived so that the real component of admittance does not become a function of ω and the imaginary component thereof is brought close to 0 (S18). Finally, the impedance value obtained after the derived number of branched line paths 410 and the derived number of capacitive units 28 have been substituted into Equation (13) is adjusted so that this impedance value becomes the impedance in the high-frequency signal processing unit 20 (S20). Note that the implementation order of S14 and S16 may be reversed.

According to the present embodiment, the number of branched line paths 410 is adjusted according to the frequency band so that the impedance in the signal path is matched with the impedance of the high-frequency signal processing unit 20. The number of branched line paths is adjusted so that the imaginary component of impedance in the frequency band in a path leading from the high-frequency signal processing unit 20 to the antenna is brought close to 0 and the real component thereof is brought close to the real component of impedance in the high-frequency signal processing unit. As a result, the stable impedance matching can be easily achieved in a desired frequency band without depending on the frequency. Also, since the imaginary component is brought close to 0, the impedance to be matched is turned into a pure resistance component. Thus the impedance of the high-frequency signal processing unit 20 can be easily adjusted. Also, the number of branched line paths 410 and the number of capacitive units 28 are adjusted so that the impedance in the frequency band in a path leading from the high-frequency signal processing unit 20 to the antenna is matched with the impedance of the high-frequency signal processing unit 20. As a result, design flexibility can be enhanced and therefore a signal processing circuit where the impedance matching is stably achieved can be designed with ease. Also, excellent communications can be achieved by the provision of a signal processing circuit where the impedance matching has been achieved.

The present invention has been described based on some embodiments. These embodiments are merely exemplary, and it is understood by those skilled in the art that various modifications to the combination of each component and each process thereof are possible and that such modifications are also within the scope of the present invention.

In the embodiment of the present invention, a description has been given where the impedance matching is achieved by adjusting the number of branched line paths 410 and the number of capacitive units 28. However, this should not be considered as limiting and, for example, the length of the bonding wire 24, the area of the electrode pad 26 or the element size of the capacitive unit 28 may be adjusted also. The impedance can be adjusted by adjusting these. Accordingly, the optimum number of branched line paths 410 and the optimum number of capacitive units 28 can be derived and the impedance matching state can be achieved. A description has been given of the impedance matching in a reception system of the radio apparatus. However, this is not limited thereto and it goes without saying that the present invention is applicable to a transmission system, an amplifier circuit for use in local signals and the like in a similar manner so as to realize a high-frequency apparatus of a wide band and excellent matching state.

Also, a description has been given where the number of branched line paths 410 and the number of capacitive units 28 are adjusted so that the real component of impedance is fixed and the imaginary component is brought close to 0. Here, return loss in the signal path 400 determined by the inductance component and the capacitance component contained in a path leading from the high-frequency signal processing unit 20 to the antenna 10 may be used as an object function by which to derive the optimum number of branched line paths 410 and the optimum number of capacitive units 28. The object function in this case may be set so that the return loss is brought close to 0. For example, the return loss may be determined as follows. By employing such an embodiment as this, further satisfactory impedance matching can be achieved.

$$\begin{matrix}RL = 20 log ( \frac{{Z}_{total} - {R}_{i n}}{{Z}_{total} + {R}_{i n}} ) \\ = 20 log [ \frac{\sqrt{{( \begin{matrix}{Re}^{2} ( {Z}_{total} ) + {Im}^{2} ( {Z}_{total} ) - \\ {R}_{ i n}^{2} ) + {( 2 Im ( {Z}_{total} ) {R}_{i n} )}^{2}\end{matrix} )}^{2}}}{{( Re ( {Z}_{total} ) + {R}_{i n} )}^{2} + {Im}^{2} ( {Z}_{total} )} ]\end{matrix} \qquad Equation ( 21 )$$

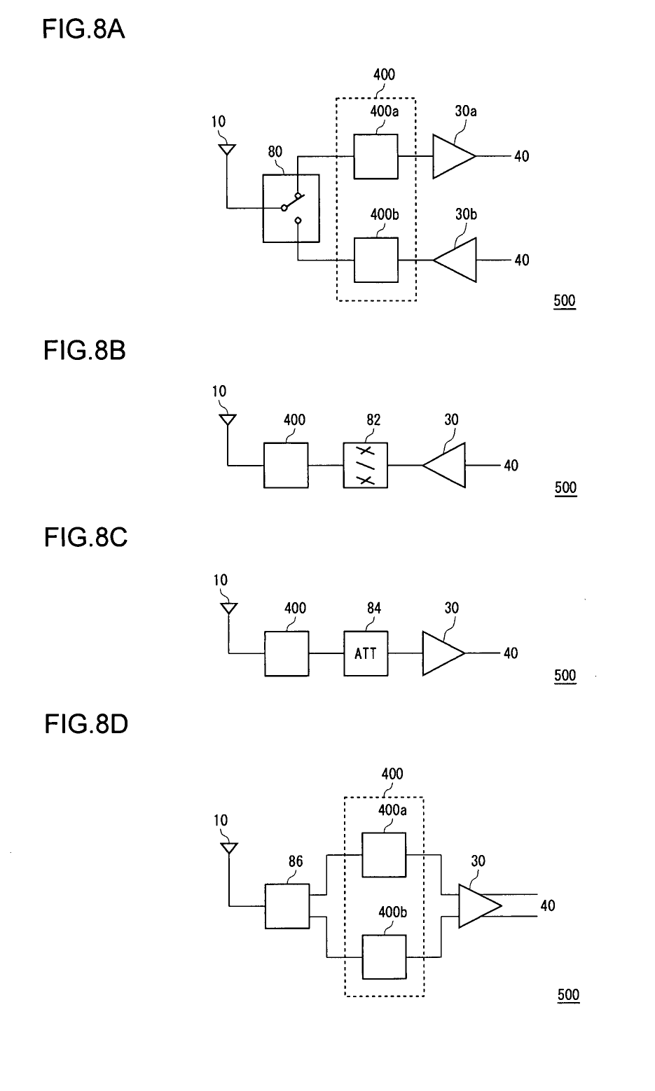

Though in the above embodiment a description has been given of the radio apparatus 100 as shown in FIG. 1, there may be provided a radio apparatus 500 as shown in FIGS. 8A to 8D. FIGS. 8A to 8D illustrate exemplary structures of modifications to the embodiment of the present invention. The radio apparatus 500 shown in FIG. 8A includes an antenna 10, a changeover switch 80, a reception system circuit comprised of a first signal path 400a and a first amplifier circuit 30a, and a transmission system circuit comprised of a second signal path 400b and a second amplifier circuit 30b. Note that the first signal path 400a and the second signal path 400b are hereinafter generically referred to as “signal path 400” also. As shown in FIG. 8A, the changeover switch 80 may be inserted between the antenna 10 and the signal path 400. Also, the changeover switch 80 may be connected with the first amplifier circuit 30a and the second amplifier circuit 30b, and a 1-system signal path may be inserted between the antenna 10 and the changeover switch 80. Thereby, transmit/receive processing can be switched.

A radio apparatus 500 shown in FIG. 8B includes an antenna 10, a signal path 400, a filter 82 and an amplifier circuit 30. FIG. 8B shows a case where the filter 82 is inserted between the signal path 400 and the amplifier circuit 30, but the filter 82 may be inserted between the antenna 10 and the signal path 400 instead. Thereby, any unnecessary band can be removed.

A radio apparatus 500 shown in FIG. 8C includes an antenna 10, a signal path 400, a variable attenuator 84 and an amplifier circuit 30. FIG. 8C shows a case where the variable attenuator 84 is inserted between the signal path 400 and the amplifier circuit 30, but the variable attenuator 84 may be inserted between the antenna 10 and the signal path 400 instead. Thereby, the dynamic range can be adjusted.

A radio apparatus shown in FIG. 8D includes an antenna 10, a signal path 400, a balun 86 and an amplifier circuit 30. The balun 86 indicates a balance-to-unbalance converting device. As shown in FIG. 86D, two signals outputted from the balun 86 are each outputted to a baseband signal processing unit 40 via the signal path 400 and the amplifier circuit 30. Thereby, the adverse effect of external noise can be reduced.

As described above, it goes without saying that the same advantageous effects are achieved by the radio apparatus 500, as shown in FIG. 8, according to the modifications to the embodiment of the present invention.

While the preferred embodiments of the present invention have been described using specific terms, such description is for illustrative purposes only, and it is to be understood that changes and variations may be further made without departing from the spirit or scope of the appended claims.

What is claimed is:

1. A signal processing circuit, comprising:
an antenna which transmits and receives a signal of a predetermined frequency band;
a high-frequency signal processing unit which performs a signal processing on the signal transmitted from and received by said antenna; and
a signal path which connects said antenna with said high-frequency processing unit,
wherein said signal path is structured in a manner such that, at one point between said antenna and said high-frequency signal processing unit, said signal path is branched out to a plurality of branched line paths that each include at least an inductance component and a capacitance component and, at another point therebetween, the respective branched-out branched line paths are combined together, and
wherein the number of the plurality of branched line paths is adjusted in a manner such that an impedance across the signal path leading from said high-frequency signal processing unit to said antenna is matched with an impedance of said high-frequency signal processing unit in the predetermined frequency band.

2. A signal processing circuit according to claim 1, wherein said high-frequency signal processing unit has an impedance that contains a real component and an imaginary component which is brought close to 0 relative to the real component, and
wherein the number of branched line paths is adjusted in such a manner that the imaginary component of impedance across the signal path leading from said high-frequency signal processing unit to said antenna in the frequency band is brought close to 0 and the real component thereof is brought close to the real component of the impedance of said high-frequency signal processing unit.

3. A signal processing circuit according to claim 1, wherein the number of branched line paths is adjusted in such a manner that return loss, in said signal path, determined by the inductance component and the capacitance component contained in the signal path leading from said high-frequency signal processing unit to said antenna is brought close to 0.

4. A signal processing circuit according to claim 1, further comprising at least one capacitance element one end of which is connected and the other end of which is grounded wherein the at least capacitance element is provided at a stage subsequent to a point where the branched-out line paths connected to said antenna are combined together,
wherein the number of branched line paths and the number of capacitance elements are adjusted in such a manner that the impedance across the signal path leading from said high-frequency signal processing unit to said antenna is matched with the impedance of said high-frequency signal processing unit in the predetermined frequency band.

5. A radio apparatus, comprising:
a signal processing circuit according to claim 1; and
a communication executing unit, connected to said signal processing circuit, which performs wireless communications.

6. An impedance method for matching, in a predetermined frequency band, an impedance of a high-frequency signal processing unit with an impedance across a signal path leading from a high-frequency signal processing unit to an antenna in a signal processing circuit comprised of the antenna which transmits and receives a signal of the predetermined frequency band, the high-frequency signal processing unit which performs a signal processing on the signal transmitted from and received by the antenna, and the signal path which connects the antenna with the high-frequency processing unit, the method comprising:
determining the frequency;
configuring the signal path in such a manner that, at one point between the antenna and the high-frequency signal processing unit, the signal path is branched out to a plurality of branched line paths that each include at least an inductance component and a capacitance component and, at another point therebetween, the respective branched-out branched line paths are combined together;
adjusting the number of branched line paths according to the frequency band determined by said determining in such a manner that an imaginary component of impedance across the signal path leading from the high-frequency signal processing unit to the antenna in the frequency band is brought close to 0 and the real component thereof is practically constant; and
adjusting the impedance of the high-frequency signal processing unit in such a manner that after having carried out said adjusting the number of branched line paths, the impedance of the high-frequency signal processing unit is brought close to the impedance across the signal path leading from the high-frequency signal processing unit to the antenna in the predetermined frequency band.

7. A method for manufacturing a signal processing circuit comprised of an antenna which transmits and receives a signal of a predetermined frequency band, a high-frequency signal processing unit which performs a signal processing on the signal transmitted from and received by the antenna, and a signal path which connects the antenna with the high-frequency processing unit wherein the signal processing circuit is such that an impedance of the high-frequency signal processing unit is matched with an impedance across the signal path leading from the high-frequency signal processing unit to the antenna in the predetermined frequency band, the method comprising:
frequency processing unit, the method comprising:
determining the frequency;
configuring the signal path in such a manner that, at one point between the antenna and the high-frequency signal processing unit, the signal path is branched out to a plurality of branched line paths that each include at least an inductance component and a capacitance component and, at another point therebetween, the respective branched-out branched line paths are combined together;
adjusting the number of branched line paths according to the frequency band determined by said determining in such a manner that an imaginary component of impedance across the signal path leading from the high-frequency signal processing unit to the antenna in the frequency band is brought close to 0 and the real component thereof is practically constant; and
adjusting the impedance of the high-frequency signal processing unit in such a manner that after having carried out said adjusting the number of branched line paths, the impedance of the high-frequency signal processing unit is brought close to the impedance across the signal path leading from the high-frequency signal processing unit to the antenna in the predetermined frequency band.
